(19) United States
(12) Patent Application Publication
(10) Pub. No.: US 2019/0137731 A1
(43) Pub. Date: May 9, 2019

(54) LIGHT FIELD ADAPTER FOR INTERCHANGEABLE LENS CAMERAS

(71) Applicant: SONY CORPORATION, Tokyo (JP)

(72) Inventor: Alexander Berestov, San Jose, CA (US)

(73) Assignee: SONY CORPORATION, Tokyo (JP)

(21) Appl. No.: 16/007,564

(22) Filed: Jun. 13, 2018

Related U.S. Application Data
(60) Provisional application No. 62/581,107, filed on Nov. 3, 2017.

(51) Int. Cl. G02B 7/14; G02B 7/02; G02B 3/00; G03B 17/56; G02B 27/58; G02B 27/22

(52) U.S. Cl. CPC G02B 7/14; G02B 7/021; G02B 27/2214; G03B 17/565; G02B 27/58; G02B 3/0043

(57) ABSTRACT

A light-field adaptor for an interchangeable lens camera having an adaptor housing including a first end configured to be received in a mount interface of a camera and a second end configured to be coupled to a mount interface of an interchangeable lens, and a lens array disposed within the housing. The lens array includes a plurality of lenses disposed at a plurality of distances from the camera sensor and illuminates different areas of the sensor to capture information about the light field emanating from a scene. The lens array may be sized and positioned to use a captured light field to generate one or more of infinite—depth of field rendering, shallow depth of field rendering, and images focused at different scene depths.

### CROSS-REFERENCE TO RELATED APPLICATIONS

This application claims priority to, and the benefit of, U.S. provisional patent application Ser. No. 62/581,107 filed on Nov. 3, 2017, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to camera optics, and more particularly to a light field adaptor for interchangeable lens cameras.

### 2. Background Discussion

In a typical light-field camera, an array of optically identical micro-lenses is inserted between the sensor and the main lens of the camera. Images captured from the light field are very low resolution, narrow angle and require good illumination.

In the Adobe light-field camera, an array of optically identical lenses is inserted in front of the main lens. Images captured at slightly different angles, which allows refocusing. However, the quality is not good.

The L16 light-field camera by Light Company incorporates 10 or more cameras that fire simultaneously, capturing slightly different perspectives of the same scene. The L16 camera chooses a combination of its 28 mm, 70 mm, and 150 mm modules to use in each shot, depending on the level of zoom. These individual shots are then computationally fused together to create an incredibly high-resolution 52 MP photograph.

Accordingly, an object of the present description is an adapter configured to transform any interchangeable lens camera into a light field camera, instead of having an expensive specialized light field camera.

### BRIEF SUMMARY

An aspect of the present disclosure is a light-field adapter that can work with multiple lenses and focus multiple images on one sensor. In one embodiment, the light field adaptor is configured to be received between the camera and interchangeable lens, and comprises an array or lenses at different focal depth configured to illuminate the camera sensor to capture information about the light field emanating from a scene.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1 is side sectional view of a light-field adaptor for interchangeable-lens cameras in accordance with the present disclosure.

FIG. 2 is front view of the light-field adaptor of FIG. 1.

FIG. 3 is side view of the light-field adaptor of FIG. 1 disposed between a camera and interchangeable lens.

FIG. 4 is side view of the light-field adaptor of FIG. 1 and secondary adaptor in accordance with the present description.

### DETAILED DESCRIPTION

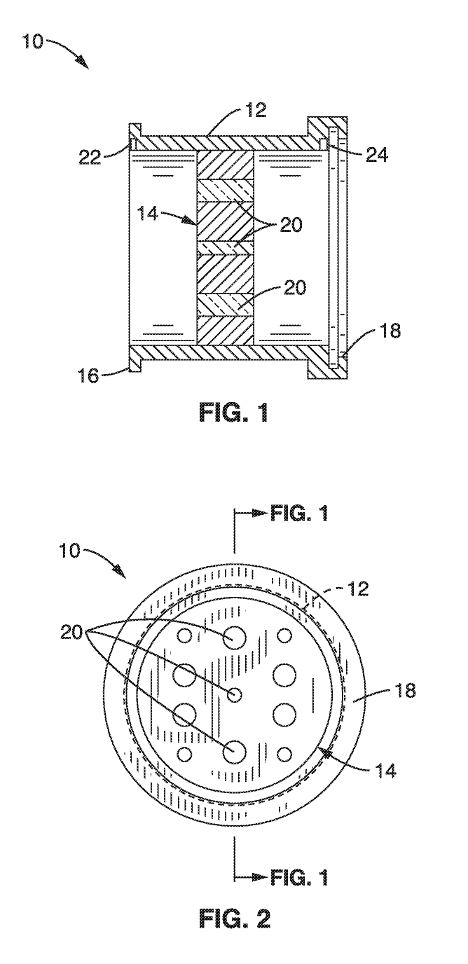

FIG. 1 is side sectional view of a light-field adaptor 10 for interchangeable-lens cameras in accordance with the present disclosure. FIG. 2 shows a front view of the light-field adaptor 10.

Light-field adaptor 10 comprises an adaptor housing 12 configured for housing a lens array 14. The adaptor housing 12 comprises a male receiver 16 configured to be received into the female mount of a camera body, and female receiver 18 configured to receive a male mount of an interchangeable lens. Where appropriate the male receiver 16 may comprise electrical contacts 22 for communicating with the camera and the female receiver may have electrical contacts 24 for communicating with the interchangeable lens.

As shown in FIG. 2, the lens array 14 comprises an array of individual lenses 20 each configured to focus on a different part of the camera sensor, e.g. to generate a light-field affect. The lens array 20 may comprise lenses of different focal length or zoom, e.g. 28 mm, 70 mm, and 150 mm modules to use in each shot.

In typical interchangeable lens cameras, lenses are generally only interchangeable within the “mount system” for which they are built, as there is almost no commonality between different camera makers regarding lens mount systems. The male receiver 16 and female receiver 18 may be configured to be compatible with various mount systems, such as the Four Thirds System using either the M42 lens mount compatible with Leica, Nikon, Pentax, Canon, Zenit, Praktica, Fujica, or the M39 mount (also known as LTM (Leica Thread Mount)) used by Leica and Contax and several Leica copies.

The male receiver 16 and female receiver 18 may also be configured to be compatible with Canon EF and EFS lens mounts, Micro Four Thirds mounts developed by Olympus and Panasonic, the Minolta A-mount system, and the Nikon F-mount system.

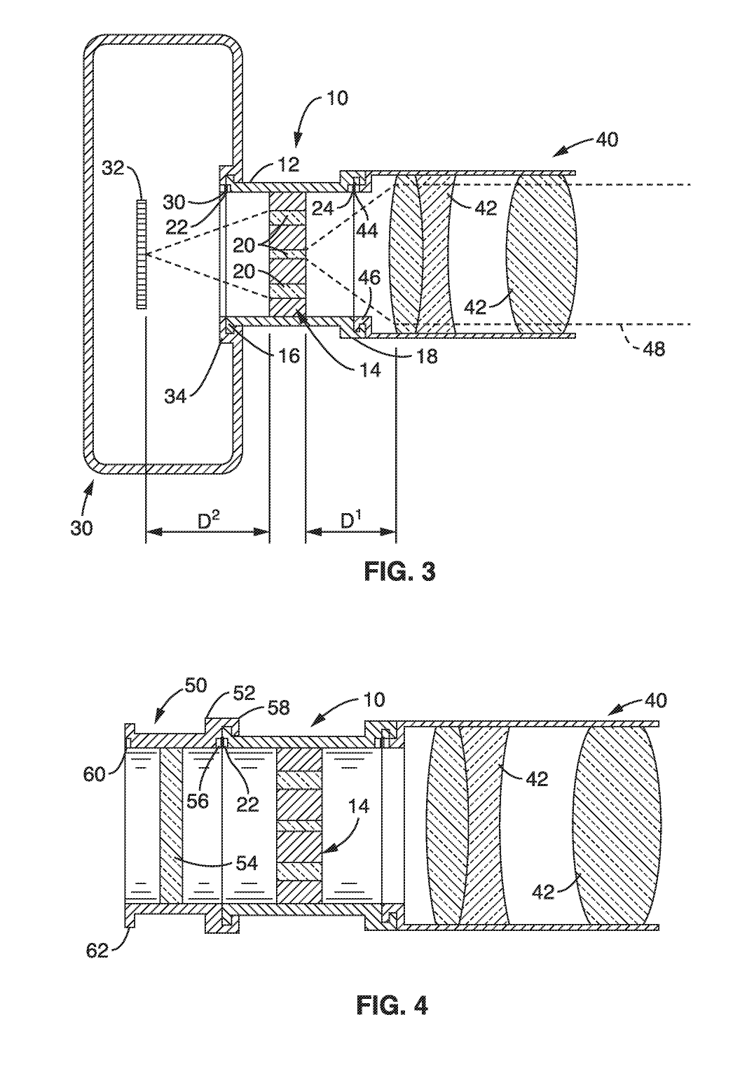

FIG. 3 is side view of the light-field adaptor 10 of FIG. 1 disposed between a camera 30 and interchangeable lens 40. When installed, the male receiver 16 of adaptor 10 is received into the female mount 34 of the camera 32 body, and the female receiver 18 receives the male mount 46 of the interchangeable lens 50. Where appropriate, the male receiver 16 may comprise electrical contacts 22 configured to align when mounted with the electrical contacts 36 of the camera 30, and the female receiver 18 may have electrical contacts 24 configured to align with electrical contacts 44 of the interchangeable lens 40. Thus, contacts 22/24 electrically couple the camera 30 with the lens 40 to allow for communication and power delivery between the two to drive lens 40 autofocus, aperture control, zoom, sensing, or other commands/operations.

As seen in FIG. 3, light entering the interchangeable lens 40 is shaped by lenses 42, and has a focal length D₁ and registration distance that is generally a specified distance from male mount to the camera sensor 32 plane. The lens array 14 is preferable positioned in the adaptor housing 12 so as to be located near the focal plane of the lens 40. The array 14 of individual lenses 20 in array 14 are each configured to focus on a different part of the camera sensor 32 at specified distance D₂. Each of the lenses 20 in light-field array 14 may be configured to have a different focal length or zoom to allow one or more of: super resolution (reconstruction of a higher-resolution image), infinite depth of field rendering (creation of all-in-focus image), shallow depth of field rendering (only object if interest is in focus), digital refocusing (generation of images focused at different scene depths)), depth map calculation from a single shot, and high-quality 3D imaging.

FIG. 4 is side view of the light-field adaptor 10 of FIG. 1 and secondary adaptor 50 in accordance with the present description. The secondary adaptor 50 may comprise an adaptor housing 52 having a particular size and accompanied with a female receiver 58 and male receiver 62 (along with corresponding electrical contacts 56 and 60) to accommodate mounts of varying lenses and cameras. The secondary adapter 50 may include an additional optical element 54 to correct for varied registration distances (the distance from the rear of the mount to the focal plane on the image sensor 32). The secondary adaptor 50 may also comprise contacts 56/60 to match certain mount configurations to mitigate any potential loss of functionality (e.g. lack of autofocus or automatic aperture control).

An alternative or additional secondary adaptor (not shown) may similarly be located between adaptor 10 and interchangeable lens 40, and may be used in conjunction with or instead of adaptor 50. In this configuration, the secondary adaptor would comprise a secondary adaptor housing having a female receiver configured to mount to the male mount of the interchangeable lens 40 and male receiver configured to mount to the female receiver of the light-field adaptor 10. This secondary adaptor may also be configured to accommodate a specific mount interface of varying interchangeable lenses and corresponding cameras, and incorporate lenses and contacts 56/60 to match certain mount configurations to mitigate any potential loss of functionality (e.g. lack of autofocus or automatic aperture control).

The light-field adapter 10 may be configured to utilize all the applications that are available for light field cameras, and have other additional advantages, including one or more of: super resolution (reconstruction of a higher-resolution image), infinite depth of field rendering (creation of all-in-focus image), shallow depth of field rendering (only object if interest is in focus), digital refocusing (generation of images focused at different scene depths), depth map calculation from a single shot, and high quality 3D imaging.

The light-field adaptor of the present description may be compatible for any lens, including telephoto lenses.

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general-purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple embodiments which include, but are not limited to, the following:

1. A light-field adaptor for an interchangeable lens camera, comprising: an adaptor housing comprising a first end configured to be received in a mount interface of a camera and a second end configured to be coupled to a mount interface of an interchangeable lens; and a lens array disposed within the housing; and wherein the lens array comprises a plurality of lenses disposed at a plurality of distances from a sensor of the camera such that each of the plurality of lenses illuminate different areas of a sensor to capture information about a light field emanating from a scene.

2. The light-field adaptor of any of the preceding or subsequent embodiments, wherein the adaptor housing comprises a male receiver configured to be received into the female mount of the camera body, and female receiver configured to receive a male mount of the interchangeable lens.

3. The light-field adaptor of any of the preceding or subsequent embodiments wherein the male receiver comprises one or more electrical contacts for communicating with the camera and the female receiver comprises one or more electrical contacts for communicating with the interchangeable lens.

4. The light-field adaptor of any of the preceding or subsequent embodiments, wherein lens array is disposed at a location in the adaptor housing corresponding to a registration distance of the interchangeable lens and camera sensor.

5. The light-field adaptor of any of the preceding or subsequent embodiments, wherein the plurality of lenses of the lens array are configured and positioned to focus on the camera sensor and the captured light field is used to generate a super-resolution image.

6. The light-field adaptor of any of the preceding or subsequent embodiments, wherein the plurality of lenses of the lens array are configured and positioned to use the captured light field to generate one or more of infinite—depth of field rendering, shallow depth of field rendering, and images focused at different scene depths.

7. The light-field adaptor of any of the preceding or subsequent embodiments, wherein the plurality of lenses of the lens array are configured and positioned to provide one or more of depth map calculation from a single shot, and high-quality 3D imaging.

8. The light-field adaptor of any of the preceding or subsequent embodiments, further comprising: a secondary adaptor comprising a secondary adaptor housing having a female receiver configured to mount to the male receiver of the adaptor housing and male receiver configured to mount to the mount interface of the camera; wherein the secondary adaptor is configured to accommodate a specific mount interface of varying interchangeable lenses and corresponding cameras.

9. The light-field adaptor of any of the preceding or subsequent embodiments, wherein the secondary adaptor housing comprises an additional optical element configured to correct for varied registration distances interchangeable lenses and corresponding cameras.

10. The light-field adaptor of any of the preceding or subsequent embodiments wherein the secondary adaptor housing further comprises one or more electrical contacts to match a specific mount configuration inherent to an interchangeable lens and corresponding camera.

11. The light-field adaptor of any of the preceding or subsequent embodiments, further comprising: a secondary adaptor comprising a secondary adaptor housing having a female receiver configured to mount to the male mount of interchangeable lens and male receiver configured to mount to the female receiver of the light-field adaptor; wherein the secondary adaptor is configured to accommodate a specific mount interface of varying interchangeable lenses and corresponding cameras.

12. An apparatus for generating a light-field image on an interchangeable lens camera, comprising: an adaptor housing comprising a first end configured to be received in a mount interface of a camera and a second end configured to be coupled to a mount interface of an interchangeable lens; a lens array disposed within the housing; and wherein the lens array comprises a plurality of lenses each configured to variably illuminate a sensor of the camera to generate a light-field effect on an image captured by the camera.

13. The apparatus of any of the preceding or subsequent embodiments, wherein the adaptor housing comprises a male receiver configured to be received into the female mount of the camera body, and female receiver configured to receive a male mount of the interchangeable lens.

14. The apparatus of any of the preceding or subsequent embodiments, wherein the male receiver comprises one or more electrical contacts for communicating with the camera and the female receiver comprises one or more electrical contacts for communicating with the interchangeable lens.

15. The apparatus of any of the preceding or subsequent embodiments, wherein lens array is disposed at a location in the adaptor housing corresponding to a registration distance of the interchangeable lens and camera sensor.

16. The apparatus of any of the preceding or subsequent embodiments, wherein the plurality of lenses of the lens array are configured and positioned to focus on the camera sensor, such that a resulting captured light field is used to generate a super-resolution image.

17. The apparatus of any of the preceding or subsequent embodiments, wherein the plurality of lenses of the lens array are configured and positioned to provide one or more of infinite—depth of field rendering, shallow depth of field rendering, and images focused at different scene depths.

18. The apparatus of any of the preceding or subsequent embodiments, wherein the plurality of lenses of the lens array are configured and positioned to provide one or more of depth map calculation from a single shot, and high-quality 3D imaging.

19. The apparatus of any of the preceding or subsequent embodiments, further comprising: a secondary adaptor comprising a secondary adaptor housing having a female receiver configured to mount to the male receiver of the adaptor housing and male receiver configured to mount to the mount interface of the camera; wherein the secondary adaptor is configured to accommodate a specific mount interface of varying interchangeable lenses and corresponding cameras.

20. The apparatus of any of the preceding or subsequent embodiments, wherein the secondary adaptor housing comprises an additional optical element configured to correct for varied registration distances interchangeable lenses and corresponding cameras.

21. The apparatus of any of the preceding or subsequent embodiments, wherein the secondary adaptor housing further comprises one or more electrical contacts to match a specific mount configuration inherent to an interchangeable lens and corresponding camera.

22. The apparatus of any of the preceding or subsequent embodiments, further comprising: a secondary adaptor comprising a secondary adaptor housing having a female receiver configured to mount to the male mount of the interchangeable lens and male receiver configured to mount to the female receiver of the light-field adaptor; wherein the secondary adaptor is configured to accommodate a specific mount interface of varying interchangeable lenses and corresponding cameras.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A light-field adaptor for an interchangeable lens camera, comprising:
an adaptor housing comprising a first end configured to be received in a mount interface of a camera and a second end configured to be coupled to a mount interface of an interchangeable lens; and
a lens array disposed within the housing; and
wherein the lens array comprises a plurality of lenses disposed at a plurality of distances from a sensor of the camera such that each of the plurality of lenses illuminate different areas of a sensor to capture information about a light field emanating from a scene.

2. The light-field adaptor of claim 1, wherein the adaptor housing comprises a male receiver configured to be received into the female mount of the camera body, and female receiver configured to receive a male mount of the interchangeable lens.

3. The light-field adaptor of claim 2, wherein the male receiver comprises one or more electrical contacts for communicating with the camera and the female receiver comprises one or more electrical contacts for communicating with the interchangeable lens.

4. The light-field adaptor of claim 1, wherein lens array is disposed at a location in the adaptor housing corresponding to a registration distance of the interchangeable lens and camera sensor.

5. The light-field adaptor of claim 1, wherein the plurality of lenses of the lens array are configured and positioned to focus on the camera sensor and the captured light field is used to generate a super-resolution image.

6. The light-field adaptor of claim 1, wherein the plurality of lenses of the lens array are configured and positioned to use the captured light field to generate one or more of infinite—depth of field rendering, shallow depth of field rendering, and images focused at different scene depths.

7. The light-field adaptor of claim 1, wherein the plurality of lenses of the lens array are configured and positioned to provide one or more of depth map calculation from a single shot, and high-quality 3D imaging.

8. The light-field adaptor of claim 2, further comprising:
a secondary adaptor comprising a secondary adaptor housing having a female receiver configured to mount to the male receiver of the adaptor housing and male receiver configured to mount to the mount interface of the camera;
wherein the secondary adaptor is configured to accommodate a specific mount interface of varying interchangeable lenses and corresponding cameras.

9. The light-field adaptor of claim 8, wherein the secondary adaptor housing comprises an additional optical element configured to correct for varied registration distances interchangeable lenses and corresponding cameras.

10. The light-field adaptor of claim 8, wherein the secondary adaptor housing further comprises one or more electrical contacts to match a specific mount configuration inherent to an interchangeable lens and corresponding camera.

11. The light-field adaptor of claim 2, further comprising:
a secondary adaptor comprising a secondary adaptor housing having a female receiver configured to mount to the male mount of interchangeable lens and male receiver configured to mount to the female receiver of the light-field adaptor;
wherein the secondary adaptor is configured to accommodate a specific mount interface of varying interchangeable lenses and corresponding cameras.

12. An apparatus for generating a light-field image on an interchangeable lens camera, comprising:
an adaptor housing comprising a first end configured to be received in a mount interface of a camera and a second end configured to be coupled to a mount interface of an interchangeable lens;
a lens array disposed within the housing; and
wherein the lens array comprises a plurality of lenses each configured to variably illuminate a sensor of the camera to generate a light-field effect on an image captured by the camera.

13. The apparatus of claim 12, wherein the adaptor housing comprises a male receiver configured to be received into the female mount of the camera body, and female receiver configured to receive a male mount of the interchangeable lens.

14. The apparatus of claim 13, wherein the male receiver comprises one or more electrical contacts for communicating with the camera and the female receiver comprises one or more electrical contacts for communicating with the interchangeable lens.

15. The apparatus of claim 12, wherein lens array is disposed at a location in the adaptor housing corresponding to a registration distance of the interchangeable lens and camera sensor.

16. The apparatus of claim 12, wherein the plurality of lenses of the lens array are configured and positioned to focus on the camera sensor, such that a resulting captured light field is used to generate a super-resolution image.

17. The apparatus of claim 12, wherein the plurality of lenses of the lens array are configured and positioned to provide one or more of infinite—depth of field rendering, shallow depth of field rendering, and images focused at different scene depths.

18. The apparatus of claim 12, wherein the plurality of lenses of the lens array are configured and positioned to provide one or more of depth map calculation from a single shot, and high-quality 3D imaging.

19. The apparatus of claim 13, further comprising:
a secondary adaptor comprising a secondary adaptor housing having a female receiver configured to mount to the male receiver of the adaptor housing and male receiver configured to mount to the mount interface of the camera;
wherein the secondary adaptor is configured to accommodate a specific mount interface of varying interchangeable lenses and corresponding cameras.

20. The apparatus of claim 19, wherein the secondary adaptor housing comprises an additional optical element configured to correct for varied registration distances interchangeable lenses and corresponding cameras.

21. The apparatus of claim 19, wherein the secondary adaptor housing further comprises one or more electrical contacts to match a specific mount configuration inherent to an interchangeable lens and corresponding camera.

22. The apparatus of claim 13, further comprising:
a secondary adaptor comprising a secondary adaptor housing having a female receiver configured to mount to the male mount of the interchangeable lens and male receiver configured to mount to the female receiver of the light-field adaptor;
wherein the secondary adaptor is configured to accommodate a specific mount interface of varying interchangeable lenses and corresponding cameras.
